(19) United States
(12) Patent Application Publication
(10) Pub. No.: US 2020/0290267 A1
(43) Pub. Date: Sep. 17, 2020

(54) Three-Dimensional Printing of Impregnated Plastics for Chemical Reactions

(71) Applicant: UCL Business PLC, London (GB)

(72) Inventors: Stephen Hilton, London (GB); Matthew Penny, London (GB); Bruno Sildos Santos, London (GB); Bhaven Patel, London (GB)

(21) Appl. No.: 16/083,960

(22) PCT Filed: Mar. 14, 2017
(86) PCT No.: PCT/GB2017/050685

§ 371 Date: Sep. 11, 2018

(30) Foreign Application Priority Data
Mar. 14, 2016 (GB) 1604322.6

(51) Int. Cl. B29C 64/124; B33Y 10/00; B33Y 70/00; B29C 64/314; B33Y 40/00; C08F 222/20

(52) U.S. Cl. CPC B29C 64/124; B33Y 10/00; B33Y 70/00; C08F 2800/20; B33Y 40/00; C08F 222/20; B29C 64/314

(57) ABSTRACT

Catalyst-impregnated articles, their uses and methods for their production, comprising curing of a light-curable liquid resin composition comprising: i) a photoinitiator; ii) at least one ethylenically unsaturated compound; and iii) a catalyst selected from the group consisting of an organocatalyst, a metal salt and a metal-ligand complex.

### FIELD OF INVENTION

The invention relates to articles, preferably laminated articles, and processes for producing such articles, i.e. three-dimensional objects, using a stereolithography resin composition. In particular, the present invention relates to an article, such as a stirrer bead holder, with an impregnated catalyst, such as an organocatalyst, a metal salt catalyst or a metal-ligand complex, to be used in organic synthesis. The invention further relates to the use of such articles in chemical reactions.

### BACKGROUND TO THE INVENTION

Three-dimensional (3D) printing has the attractive capability of allowing users to create complex architectures in excellent detail from a range of materials. Its utility is therefore being increasingly exemplified within scientific research, with applications including bioprinting for tissue growth, creating microfluidic, analytical and medical devices and bespoke laboratory equipment. These applications are a result of rapid prototyping, which allows iterative development and fine tuning at little additional cost.

Three-dimensional printing has been used to design and construct customised reactors for organic and inorganic synthesis. The ability to fabricate a reactor from inexpensive and inert polypropylene in a matter of hours, and the ability to modify the reactor if necessary, offers synthetic chemists greater control over the optimisation of flow chemistry.

Immobilised homogeneous catalysts are useful for chemical synthesis, since they can be easily removed after the reaction is complete, thereby simplifying isolation and purification procedures. However, it would be beneficial to be able to rapidly prototype immobilised homogenous catalysts of any structure, shape and size.

Accordingly, it is an object of the present invention to provide a process for producing an article which is impregnated with a catalyst, can be prepared by rapid prototyping and can be used to circumvent many separation/purification procedures involved in chemical synthesis, thereby saving resources and avoiding potential compatibility issues.

Furthermore, it is an object of the present invention to provide a process for producing an article which is impregnated with a catalyst and which exhibits good solvent resistance.

### SUMMARY OF THE INVENTION

The present invention provides articles comprising a laminated core comprising multiple layers.

Viewed from one aspect, the invention provides an article comprising a laminated core comprising multiple layers, each layer comprising the cured product of a light-curable liquid resin composition comprising:
i) a photoinitiator;
ii) at least one ethylenically unsaturated compound; and
iii) a catalyst selected from the group consisting of an organocatalyst, a metal salt and a metal-ligand complex.

Viewed from an alternative aspect, the invention provides an article comprising a laminated core comprising multiple layers, each layer comprising a catalyst selected from the group consisting of an organocatalyst, a metal salt and a metal-ligand complex, wherein said catalyst is dispersed in a matrix;

said matrix being the cured product of a light-curable liquid resin composition comprising:
i) a photoinitiator; and
ii) at least one ethylenically unsaturated compound.

In a further aspect, the invention provides methods for producing articles according to the invention.

The present invention provides a method for producing an article, said method comprising:
a) preparing a light-curable liquid resin composition comprising:
   i) a photoinitiator;
   ii) at least one ethylenically unsaturated compound; and
   iii) a catalyst selected from the group consisting of an organocatalyst, a metal salt and a metal-ligand complex;
b) curing at least one portion of the light-curable liquid resin by exposure to electromagnetic radiation; and
c) repeating step b) to form an article comprising successive layers of cured resin.

The present invention further provides an alternative method for producing an article, the method comprising:
a) preparing a light-curable liquid resin composition comprising:
   i) a photoinitiator;
   ii) at least one ethylenically unsaturated compound; and
   iii) a catalyst selected from the group consisting of an organocatalyst, a metal salt and a metal-ligand complex,
b) selectively curing at least one portion of the light-curable liquid resin by exposure to electromagnetic radiation.

The curing step (b) may be performed by means of a process comprising or consisting of three-dimensional printing, preferably vat polymerisation three-dimensional printing, such as stereolithography, continuous liquid interface production or continuous liquid interphase printing.

The at least one portion of the light-curable liquid resin may be cured or selectively cured based on instructions provided in an electronic file. After step (b), the cured portion of the light-curable liquid resin may be moved, by a distance corresponding to at least the thickness of the cured portion, away from the surface of the light-curable liquid resin, before a further portion of the light-curable liquid resin is cured and adhered to the previously cured portion. The method may further comprise a step of curing sequential layers of the light-curable liquid resin until the production of the article is complete.

The photoinitiator may be a free radical photoinitiator, a cationic photoinitiator or a combination thereof. The photoinitiator may preferably be selected from the group consisting of a phosphine oxide, an α-hydroxyketone, a benzophenone derivative, a titanocene, a thioxanthone and an onium salt and combinations thereof. The photoinitiator may be diphenyl(2,4,6-trimethylbenzoyl)phosphine oxide.

The photoinitiator may be present in the light-curable liquid resin composition in an amount of from 0.01 to 6% w/w, preferably 0.1-3% w/w, for example 1-2% w/w or 0.3-0.7% w/w, based on the total weight of the resin composition.

The ethylenically unsaturated compound may comprise or consist of at least one (meth)acrylate, (meth)acrylamide, epoxide, vinyl ether, vinyl ester, vinyl sulfonate, styrene, N-vinylpyrrolidone, vinylcaprolactam and combinations thereof. The ethylenically unsaturated compound may preferably be selected from at least one of 1,6-hexanedioldiacrylate, 2-(2-ethoxy)ethyl acrylate, 2-phenoxyethyl acrylate, isodecyl acrylate, ethoxylated-4-phenyl acrylate, 3,3,5-trimethyl cyclohexanol acrylate, iso octyl acylate, tridecyl acrylate, isobornyl acrylate, poly(ethylene glycol)diacrylate, polybutadiene diacrylate, bisphenol A propoxylate diglycidyl ether and combinations thereof. The ethylenically unsaturated compound may more preferably be selected from at least one of isobornyl acrylate, poly(ethyleneglycol)diacrylate, bisphenol A ethoxylate diacrylate and combinations thereof. Most preferably, the ethylenically unsaturated compound is poly(ethylene glycol)diacrylate and the photoinitiator is diphenyl(2,4,6-trimethylbenzoyl)phosphine oxide.

It is preferred that the ethylenically unsaturated compound is present in the light-curable liquid resin composition in an amount of greater than 30% w/w, preferably from 40-99% w/w, based on the total weight of the resin composition.

The liquid resin composition may further comprise a cross-linker. The cross-linker may preferably be a (meth)acrylate or a vinyl ether. More preferably, the cross-linker is trimethylolpropane triacrylate.

The catalyst may be an organocatalyst. The organocatalyst may be selected from the group consisting of p-toluene sulfonic acid, tris(2,2,2-trifluoroethyl)borate, (R)-(−)-1,1′-binaphthyl-2,2′-diyl hydrogenphosphate, 4-dimethylaminopyridinium acetate, piperidine and phospholane oxides. Preferably, the catalyst is p-toluene sulfonic acid monohydrate or DMAP.AcOH.

The catalyst may be present in the light-curable liquid resin composition in an amount of from 1 to 15% w/w.

The light-curable liquid resin composition may further comprise a photoinhibitor. The photoinhibitor may be selected from the group consisting of 4-methoxy phenol, Sudan I, 2-(hydroxyphenol)benzotriazole and 2-(2′-hydroxy-3′tert-butyl-5′-methylphenyl)-5-chlorobenzotriazole.

The photoinhibitor may be present in the light-curable liquid resin composition in an amount of from 0.01 to 2% w/w, preferably 0.05-0.5% w/w.

The article may be selected from the group consisting of a magnetic stirrer bar holder, a stirrer, a reaction vessel, a paddle, a cartridge for flow hydrogenation systems, an insert for a microwave reactor and a stirrer for a microwave reactor. Preferably, the article is a magnetic stirrer bar holder.

The present invention also relates to the article obtained by the process of the present invention. Preferably the methods of the present invention provide articles comprising a laminated core, according to the current invention.

Furthermore, the present invention relates to the use of the article according to the present invention or obtained from the methods of the present invention to catalyse a chemical reaction. Preferably, wherein the catalyst is p-toluene sulfonic acid monohydrate and the chemical reaction is the Mannich reaction.

The present invention also relates to articles according to the present invention where the catalyst excludes onium salts, preferably where the catalyst excludes onium salts comprising a toluene sulfonate anion.

### BRIEF DESCRIPTION OF THE FIGURES

The invention will now be described in more detail, by way of example only, and with reference to the following FIGURE, in which:

FIG. 1 illustrates the reusability of an organocatalyst-impregnated 3D printed stirrer bar holder.

### DESCRIPTION OF EMBODIMENTS

The present invention provides articles comprising a laminated core and methods for producing such articles, preferably using a stereolithography process. The inventors have found that the articles of the present invention are particularly useful in the production of valuable chemical products and intermediates, such as those within the pharmaceutical, agrochemical and other fine chemical industries.

### General Definitions

Throughout this application terms should be interpreted according to their standard meaning in the art unless specified otherwise. The following terms should be construed according to their standard meanings, as set out below.

As used in this specification and the appended claims, the singular forms “a”, “an”, and “the” include plural references unless the context clearly dictates otherwise. Thus for example, a reference to “a method” includes one or more methods, and/or steps of the type described herein and/or which will become apparent to those persons skilled in the art upon reading this disclosure and so forth.

The term “approximately” or “about” in connection with a number is intended to mean “in the region of”, i.e. within normal tolerance of the stated value. In other words, a value that the skilled worker in the relevant field would round up or round down to reach the “approximate” value. For example a value in the range of 95 to 104 would be “approximately 100”, or 0.96 to 1.04 would be “approximately 1”.

The term “at least” when used in connection with a number has its standard meaning, i.e. means that number is the minimum value for the specified parameter/component. For example “at least one polymer” means there is one or more polymer and discloses the options of one polymer or more than one polymer being present.

The term “comprising” should be construed as meaning “including but not limited to”. The term “comprising” also discloses mixtures, processes and the like “consisting essentially of” the specified features and “consisting of” the specified features. For example, a mixture disclosed herein as comprising components (a) to (d) also discloses a mixture consisting of components (a) to (d). For example, an article comprising a laminated core, also discloses an article consisting of a laminated core.

The term “free from X” or “essentially free from X” or “excludes X” means that X is not present or is present in quantities which have no significant adverse effect on the working of the invention e.g. less than 5 wt/% or preferably less than 1 wt. %, more preferably less than 0.1 wt. % based on the weight of the component, and/or has a negligible effect in terms of the relevant properties of the article. For example a negligible effect might be defined as causing a deviation in value that is within the error tolerance of the relevant measurement system or is within 5% of such a value, preferably within 2% of such a value.

The term “greater than” when used in connection with a number has its standard meaning, i.e. means that the specified parameter has a value higher than the specified number.

The term “not greater than” or “no more than” when used in connection with a number has its standard meaning, i.e. means that the specified parameter has a maximum value equal to the specified number.

The term “in the range from X to Y” has its standard meaning, i.e. the value of the parameter is a minimum of X and a maximum of Y.

As used herein, “laminated” has its standard meaning of comprising two or more layers or sheets, which may be the same or different, and are physically or chemically bound together.

As used herein, “laminated article” or “laminated object” is meant for an article or object comprising two or more separate layers, e.g. sheets or films, joined together chemically or physically to form a substantially flat multi-layered plate or sheet, where the separate layers are integrally laminated such as to be visible by means of microscopic analysis such as SEM or TEM.

The term “less than” when used in connection with a number has its standard meaning, i.e. means that the specified parameter has a value lower than the specified number.

In the context of the present invention, the terms “light-curable” and “photo-curable” are synonymous. The term “curing” has its standard meaning in the art, i.e. the toughening or hardening of a polymer material by cross-linking of polymer chains, brought about by electron beams, heat or chemical additives. In “light-curing” and “photo-curing” in the context of the present invention, curing is activated by electromagnetic radiation, typically of wavelength in the UV to visible light range of approximately 200-800 nm.

The term “Mn” or “M_{N}” has its standard meaning, i.e. number average molecular weight: the total weight of all the polymer molecules in a sample, divided by the total number of polymer molecules in a sample. Mn can be determined using techniques such as gel permeation chromatography, also known as size exclusion chromatography (GPC/SEC).

The term “Mw” or “M_{W}” has its standard meaning, i.e. weight average molecular weight: the statistical average molecular weight of all the polymer chains in the sample. This is typically determined by standard techniques such as gel permeation chromatography, also known as size exclusion chromatography (GPC/SEC).

The term “multiple” has its standard meaning, i.e. at least 2, more preferably at least 3.

The term “no less than” or “not less than” when used in connection with a number has its standard meaning, i.e. means that the specified parameter has a minimum value equal to the specified number.

The term “optionally” has its standard meaning, i.e. means that the specified feature is not essential and may or may not be present. Optional components or process steps disclose the claimed product or process including and not including the optional feature.

The term “performed using” as for example in “3D printing is performed using” has its standard meaning, i.e. when the claimed process is carried out, the specified feature applies.

The term “solid” throughout this application is used to refer to the state of matter, i.e. to distinguish from liquids and gels.

The term “surface area” throughout this application is used to refer to the specific surface area (SSA) which is a property of solids defined as the total surface area of a material per unit of mass (with units of m²/kg or m²/g), or solid or bulk volume (units of m²/m³ or m⁻¹). Surface area may be measured using standard techniques such as N₂—BET adsorption method, as well as by calculation from particle size distribution. The most commonly used method uses the BET adsorption isotherm.

The term “weight %” or “percent by weight” or “w/w” has its standard meaning throughout this application, i.e. percentage by weight based on the total weight of the relevant mixture. In other words the total weight of the mixture is 100%.

The term “w/v” or “weight/volume %” has its standard meaning throughout this application, i.e. the weight in grams of a solute per 100 milliliter of a solution. For example, a 50% w/v solution of PEG 6000 is made by adding exactly 50 grams of PEG 6000 solid to a total, final volume of 100 milliliters.

Features which are described herein with reference only to a single aspect or embodiment of the invention apply equally to all other aspects and embodiments of the invention. Hence features from one aspect or embodiment may be combined with features from another aspect or embodiment. For example, unless otherwise stated, the disclosed photoinitiators, catalysts and ethylenically unsaturated compounds may be combined in any way with each other and with the disclosed features of the methods and articles/objects according to the invention.

The photoinitiators, catalysts, ethylenically unsaturated compounds and other component materials suitable for use in the aspects and embodiments of the invention are described hereinafter individually. The skilled worker will readily understand that each component can be combined with the other components described and such combinations are applicable to all aspects and embodiments of the invention.

In this specification, unless expressly otherwise indicated, the word ‘or’ is used in the sense of an operator that returns a true value when either or both of the stated conditions is met, as opposed to the operator ‘exclusive or’ which requires that only one of the conditions is met.

All prior teachings acknowledged above are hereby incorporated by reference. No acknowledgement of any prior published document herein should be taken to be an admission or representation that the teaching thereof was common general knowledge in the United Kingdom or elsewhere at the date hereof

### Generation of Articles

The articles according to the invention may suitably be prepared by means of additive manufacturing methods such as three-dimensional printing, preferably vat polymerisation three-dimensional printing. Examples of these techniques include stereolithography, continuous liquid interface production, also known as continuous liquid interphase printing (CLIP).

In the context of the present invention, the term “stereolithography” refers to a method of generating articles from a photo-polymerisable or light-curable liquid resin composition.

In particular, stereolithography is a method for making solid articles and can be implemented by successively curing layers of a light-curable material/photosensitive liquid resin composition, e.g. a UV curable material, one on top of the other. In such a stereolithography process, a movable beam of radiation (e.g. UV light) can be applied to the surface of the photosensitive liquid resin composition in order to cure a predetermined area of the surface of the composition, i.e. selectively cure at least one portion of the resin. A solid cross-section of the article can therefore be formed at the surface of the photosensitive liquid resin composition. The article can then be moved away from the liquid surface before an uncured further layer of the photosensitive liquid resin composition is introduced on top of the first layer. For example, a suitable platform to which the first layer is secured can be moved away from the surface in a controlled manner by any appropriate actuator.

Radiation is applied to the uncured further layer of the photosensitive liquid resin composition to cure a predetermined area of the uncured further layer. Each layer represents an adjacent cross-section of the article to be produced.

As each adjacent layer is formed, successive layers are superimposed on top of each other in order to define the article. The process continues until the article has been formed.

Complex forms are more easily created by using a computer to generate the programmed commands and to then send the program signals to the stereolithographic article-forming subsystem.

Alternative systems for creating cured articles from a curable fluid are those described in U.S. Pat. Nos. 4,041,476 and 4,288,861. Each of the systems disclosed in these patents relies upon the build-up of synergistic energy at selected points within the fluid volume, to the exclusion of all other points in the fluid volume, using a variety of elaborate multibeam techniques to combine energy of the multiple beams at the selected points.

Other suitable techniques include CLIP, in which the printing process begins with a pool of liquid photo-polymerisable resin. Part of the pool bottom is transparent to ultraviolet light (the “window”). An ultraviolet light beam shines through the window, illuminating the precise cross-section of the article to be formed. The light causes the resin to solidify, by curing at least a portion of the resin, in the shape of the desired cross-section (“selectively curing”). The article rises continuously, slowly enough to allow resin to flow under and maintain contact with the bottom of the article. An oxygen-permeable membrane lies below the resin, which creates a “dead zone” (persistent liquid interface) preventing the resin from attaching to the window (photopolymerization is inhibited between the window and the polymerizer).

Other forms of appropriate stimulation can be used to cure the light-curable resin composition. For example, particle bombardment (i.e. electron beams), chemical reactions by spraying materials through a mask or by ink jets, or radiation other than ultraviolet light and visible light may also be used.

Without wishing to be bound by theory it is believed that during curing according to the processes of the invention the ethylenically unsaturated compound and photoinitiator form a mixture in which the catalyst is molecularly dispersed/dissolved. The mixture is referred to herein as a “matrix”.

Throughout this application the term “matrix” applies to the cured product of the ethylenically unsaturated polymer and photoinitiator and other optional additives, if present, and may also be applied to the cooled and solidified mixture as well as the liquid mixture. The term “matrix” requires a chemical reaction or change in the chemical structure of the ethylenically unsaturated compound, as is typically found upon curing. Preferably there is essentially no chemical alteration or degradation of the catalyst in terms of its catalytic functionality during its dispersal in the matrix and/or upon curing. In other words the catalytic performance of the catalyst is not adversely affected or is not significantly adversely affected by its dispersal in the matrix and/or upon curing. For example, catalyst performance may remain essentially the same, or at least 90%, preferably at least 95%, more preferably at least 99%, in comparison with performance of the free catalyst which is not dispersed in a matrix.

Articles according to the invention comprise a laminated core, which may suitably be manufactured as described hereinbefore. Articles according to the invention may consist essentially of said laminated core, or consist of said laminated core. Alternatively, articles according to the invention may include at least one additional outer layer, for example a coating, or a layer which has been surface-functionalised.

### Ethylenically Unsaturated Compounds

The light-curable liquid resin composition includes at least one ethylenically unsaturated compound, preferably comprising at least one polymerisable monomer or oligomer (and combinations thereof). Suitable ethylenically unsaturated compounds include (meth)acrylates, (meth)acrylamides, urethane (meth)acrylates, epoxides, vinyl ethers, vinyl esters, vinyl sulfonates, styrenes, N-vinylpyrrolidone, vinylcaprolactam and combinations thereof. Accordingly, the stereolithography light-curable liquid resin composition may comprise at least one (meth)acrylate, (meth)acrylamide, urethane (meth)acrylate, epoxide, vinyl ether, vinyl ester, vinyl sulfonate, styrene, N-vinylpyrrolidone, vinylcaprolactam and combinations thereof.

The (meth)acrylate component may be a (meth)acrylic oligomer, a (meth)acrylic monomer, a (meth)acrylic cross-linker or a combination thereof.

Suitable (meth)acrylate monomers include 1,6-hexanedioldiacrylate, 2-(2-ethoxy)ethyl acrylate, 2-phenoxyethyl acrylate, isodecyl acrylate, ethoxylated-4-phenyl acrylate, 3,3,5-trimethyl cyclohexanol acrylate, iso octyl acylate, tridecyl acrylate, isobornyl acrylate, tetrahydrofurfuryl acrylate, ethoxylated phenyl acrylates, lauryl acrylate, stearyl acrylate, octyl acrylate, tridecyl acrylate, caprolactone acrylate, nonyl phenol acrylate, methoxy poly(ethylene glycol) acrylates, methoxy poly(prolylene glycol) acrylates, hydroxyethyl acrylate, hydroxyl propyl acrylate, glycidyl acrylate and combinations thereof.

Suitable (meth)acrylate oligomers include poly(ethylene glycol)diacrylate (e.g. Mn is 150-600), polybutadiene diacrylate, bisphenol A propoxylate diglycidyl ether, tripropylene glycol diacrylate, bisphenol A polyethylene glycol diether diacrylate, 2,2′-methylenebis[p-phenylenepoly(oxyethylene)oxy]-diethyl diacrylate, ethoxylated or propoxylated Bisphenol A diacrylate, ethoxylated or propoxylated Bisphenol F diacrylate, ethoxylated or propoxylated Bisphenol S diacrylate, tetraethylene glycol diacrylate and combinations thereof. The weight average molecular weight of the acrylate oligomer may be in the range of 150 to 5000 g/mol. Preferably, the weight average molecular weight is between 200 to 3000 g/mol. This may be measured, for example, by GPC/SEC.

Preferably, the liquid resin composition comprises 1,6-hexanedioldiacrylate, 2-(2-ethoxy)ethyl acrylate, 2-phenoxyethyl acrylate, isodecyl acrylate, ethoxylated-4-phenyl acrylate, 3,3,5-trimethyl cyclohexanol acrylate, iso octyl acylate, tridecyl acrylate, isobornyl acrylate, poly(ethylene glycol)diacrylate (Mn 200 to 400), polybutadiene diacrylate, bisphenol A propoxylate diglycidyl ether and combinations thereof. More preferably, the polymerisable monomer or oligomer may be 1,6-hexanedioldiacrylate or poly(ethylene glycol)diacrylate. The inventors have found that the presence of 1,6-hexanedioldiacrylate and/or poly(ethylene glycol)diacrylate in the light-curable liquid resin gives rise to 3D printed articles which exhibit excellent solvent resistance properties.

In a preferred embodiment applicable to all aspects of the invention, the stereolithography light-curable liquid resin comprises at least one ethylenically unsaturated compound, wherein the at least one ethylenically unsaturated compound may be selected from isobornyl acrylate, poly(ethyleneglycol)diacrylate, bisphenol A ethoxylate diacrylate and combinations thereof. The ethylenically unsaturated compound preferably may have a number average molecular weight in the range of 150 to 1000, preferably 200 to 650. This may be measured, for example, by GPC/SEC.

The ethylenically unsaturated compound may be included in the resin composition in a total amount that is greater than 30% w/w, preferably from 40-99% w/w based on the total weight of the resin composition. Preferably, the ethylenically unsaturated compound is included in the resin composition in an amount of from 60-90% w/w, for example 65-85% w/w.

In the context of the present invention the term “oligomers” refers to molecules of reactive intermediate molecular weight consisting of a few monomer units, usually dimers (two units), trimers (three units) and tetramers (four units).

In the context of the present invention, the term “(meth)acrylate” means “acrylate and/or methacrylate”.

### Photoinitiator

The light-curable liquid resin composition includes at least one photoinitiator. The photoinitiator may be any compound capable of generating radicals (or cations or anions) by radiation of ultraviolet (UV) or visible light. The photoinitiator should be suitable for the wavelength of the stereolithography laser, which typically operates in the ultraviolet (UV) to visible light range of about 200 to 800 nanometers.

Photoinitiators suitable for the invention typically undergo photolysis or homolysis to generate at least two radical species. Most if not all of the photoinitiator is therefore consumed during this process. Without being bound by theory, photoinitiators typically become structurally incorporated into the polymerised/cured product and no longer function as photoinitiators thereafter. This is in contrast to catalysts suitable for the invention, which remain catalytically functional even if structurally incorporated into the cured article, for example where the catalyst includes a polymerizable ethylenic group that would be chemically modified upon curing.

The photoinitiator may be a free radical photoinitiator, a cationic photoinitiator or a combination thereof.

Suitable radical photoinitiators include mono-, bis- or trisacylphosphine oxides, α-hydroxy ketones, α-hydroxy acetophenones, acetophenones, benzophenones, α-amino ketones, Riboflavin/triethyanolamine, quinones and combinations thereof. For example, the radical photoinitiator is selected from bis(2,6-dimethoxybenzoyl)(2,4,4-trimethylpentyl)phosphine oxide, bis(2,4,6-trimethylbenzoyl)(2,4-dihexyloxyphenyl)phosphine oxide, bis(2,4,6-trimethyl-benzoyl)(4-ethoxyphenyl)phosphine oxide, bis(2,4,6-trimethylbenzoyl)phenylphosphine oxide or 2,4,6-trimethylbenzoyldiphenylphosphine oxide and the α-hydroxy ketone compound is selected from α-hydroxycyclohexyl phenyl ketone, 2,2-demiethoxyacetophenone or 1,1-dichloroacetophenone or 2-hydroxy-2-methyl-1-phenylpropan-1-one.

Suitable cationic photoinitiators include onium salts, such as iodonium and sulfonium salts.

The photoinitiator may be a phosphine oxide, a titanocene, a thioxanthone, an α-hydroxyketone, a benzophenone derivative, or a mixture thereof. Preferably, the photoinitiator is diphenyl(2,4,6-trimethylbenzoyl)phosphine oxide. The uv-vis absorbance of this photoinitiator and sensitivity at particular wavelengths of light allows it to be used with commercially available 3D SLA printers. It has also been found to exhibit the required stability for example, thermal stability at room temperature to permit convenient storage of resin compositions prior to their use.

The photoinitiator may be included in the resin composition in an amount of from 0.01-6% w/w based on the total weight of the resin composition. Preferably, the photoinitiator is included in the resin composition in an amount of from 0.1-3% w/w, for example 0.3-2.5% w/w, more preferably 1-2% w/w.

In a preferred combination, applicable to all aspects and embodiments of the invention, the ethylenically unsaturated compound may be poly(ethylene glycol)diacrylate and the photoinitiator may be diphenyl(2,4,6-trimethylbenzoyl)phosphine oxide.

### Optional Cross-Linker

The light-curable liquid resin composition may also include a cross-linking agent. Alternatively or additionally, the ethylenically unsaturated compound may also function as a cross-linking agent. For example, the ethylenically unsaturated compound may be a diacrylate (e.g. poly(ethylene glycol) diacrylate), which can also act as a cross-linking agent. Suitable cross linking agents (cross-linkers) include trifunctional, tetrafunctional or higher functional cross-linkers.

For example, the cross-linker may be a (meth)acrylate, such as pentaerythritol tetraacrylate and/or trimethylolpropane triacrylate. Other common multifunctional cross-linkers, such as vinyl ethers, may also be used in the present invention. For example, the cross-linker may be tris(2-hydroxy ethyl) isocyanurate trimethylacrylate, trimethylolpropane tri(meth)acrylate, tris(2-hydroxy ethyl isocyanurate triacrylate, dipentaerythritol pentaacrylate, tetraethylene glycol diacrylate, triethylene glycol diacrylate, pentaerythritol etraacrylate, tripropylene glycol diacrylate, di-trimethylolpropane tetraacrylate, dipentaerythritol pentaacrylate, divinyl benzene, trimethylolpropane triglycidyl ether or combinations thereof. In particular, the cross-linker may be selected from tetraethylene glycol diacrylate, triethylene glycol diacrylate, pentaerythritol etraacrylate, tripropylene glycol diacrylate, di-trimethylolpropane tetraacrylate, dipentaerythritol pentaacrylate, divinyl benzene, trimethylolpropane triglycidyl ether and combinations thereof. Preferably the cross-linking agent is trimethylolpropane triacrylate.

A cross-link is a bond that links one polymer chain to another. These bonds can typically be covalent bonds or ionic bonds.

The cross-linking agent may suitably be included in the resin composition in an amount of from 2-20% w/w based on the total weight of the resin composition. Preferably, the cross-linker is included in the resin composition in an amount of from 8-18% w/w.

### Catalyst

The catalyst is selected from the group consisting of organocatalyst, metal salt catalysts, metal-ligand complexes and combinations thereof.

The catalyst may typically be included in the resin composition in an amount of from 0.05-20% w/w based on the total weight of the resin composition. Preferably, the catalyst is included in the resin composition in an amount of from 1-15% w/w such as 2-14% w/w or 5-10% w/v, more preferably in an amount of from 6-12% w/w.

In one embodiment, applicable to all aspects of the invention, the catalyst may contain ethylenically unsaturated groups which can be incorporated into the polymerised/cured structure. In this embodiment, the catalyst may typically be included in the resin composition in an amount from 0.05-40% w/w based on the total weight of the resin composition.

One of the advantages provided by the current invention is the catalytic activity of the laminated articles provided. In other words, the ability of the organocatalyst, metal salt or metal-ligand complex to function as a catalyst is unaffected or not significantly adversely affected by its incorporation in the cured resin composition.

Suitable metal salt or oxide catalysts include salts or oxides of Li, Na, Mg, Al, Si, K, Ca, Sc, Ba, Ti, V, Cr, Mn, Fe, Co, Ni, Cu, Zn, Sr, Y, Zr, Nb, Mo, Ru, Rh, Pd, Ag, Sn, La, Hf, W, Re, Ir, Pt, Au, Pb, Yb, Bi, Tl, Ce, Sm and combinations thereof. Preferably, the metal salt catalyst is selected from copper(I) trifluoromethanesulfonate, copper(II) trifluoromethansulfonate, copper (I) acrylate, copper(II) acrylate, copper (I) methacrylate, copper(II) methacrylate, copper(I) maleate, copper(II) maleate, copper(I) fumarate, copper (II) fumarate, palladium(II) acetate, palladium(II) chloride and platinum(IV) oxide.

Preferably the metal salt may be selected from copper(I) trifluoromethanesulfonate, copper(II) trifluoromethansulfonate, zinc(II) trifluoromethansulfonate, scandium(III) trifluoromethanesulfonate, palladium(II) acetate or palladium(II) chloride.

Preferably the metal salt is included in the resin composition in an amount of from 1-10% w/w based on the total weight of the resin composition.

In the context of the present invention, the term “metal-ligand complex” refers to an assembly of one or more central metal atoms formed through coordination bonds with ligands and having a net neutral, positive or negative charge. Ligand or complexing agent refers to atoms or groups of atoms which form coordination bonds to another atom, defined as the central atom.

Suitable metal-ligand complexes include Li, Na, Mg, Al, Si, K, Ca, Sc, Ba, Ti, V, Cr, Mn, Fe, Co, Ni, Cu, Zn, Sr, Y, Zr, Nb, Mo, Ru, Rh, Pd, Ag, Sn, La, Hf, W, Re, Ir, Pt, Au, Pb, Yb, Bi, Tl, Ce, Sm and combinations thereof, or salts thereof, in combination with one or more ligands. Suitable ligands include phosphine, amine, imine, amide, carboxylate, heterocycle, bisoxazoline, N-heterocyclic carbene, alkyl, alkenyl, dienyl, aryl, carbon monoxide, cyanide, carbene, nitrile, sulfide, nitride, oxylate, alkoxy, amine oxide, halide, alcohol, phenol, binol (and derivatives), ether and Salen. The ligand may be a bi-, tri- or tetradentate ligand containing one or more of the functionalities listed above. Preferably, the metal-ligand complex may be selected from (1,3-Bis(2,4,6-trimethylphenyl)-2-imidazolidinylidene)dichloro(phenylmethylene)(tricyclohexylphosphine)ruthenium, Benzylidene-bis(tricyclohexylphosphine)dichlororuthenium, Hexaammineruthenium(III) chloride, (R)-[2,2′-Bis(diphenylphosphino)-1,1′-binaphthyl]dichlororuthenium, (S)-[2,2′-Bis(diphenylphosphino)-1,1′-binaphthyl]dichlororuthenium, Hydroxy[-(R)-BINAP]-rhodium(I) Dimer, Hydroxy[-(S)-BINAP]-rhodium(I) Dimer, Tris(triphenylphosphine)rhodium(I) chloride, Bis(triphenylphosphine)palladium(II) dichloride, Palladium(II) acetylacetonate, [1,1′-Bis(diphenylphosphino)ferrocene]dichloropalladium(II), Tetrakis(triphenylphosphine)palladium(0), Tris(dibenzylideneacetone)dipalladium(0) and Bis(dibenzylideneacetone)palladium(0).

More preferably, the metal-ligand complex may be selected from (1,3-Bis(2,4,6-trimethylphenyl)-2-imidazolidinylidene)dichloro(phenylmethylene)(tricyclohexylphosphine)ruthenium, Tris(triphenylphosphine)rhodium(I) chloride, Bi s(triphenylphosphine)palladium(II) dichloride, Tetrakis(triphenylphosphine)palladium(0) or Tri s(dibenzylideneacetone)dipalladium(0).

Preferably the metal-ligand complex is included in the resin composition in an amount of from 0.1-10% w/w based on the total weight of the resin composition.

In the context of the present invention, the term “organocatalyst” refers to an organic compound that functions as a catalyst, i.e. a substance that increases the rate of a reaction without modifying the overall standard Gibbs energy change in the reaction. Specific examples of suitable organocatalysts for use in the present invention include aryl sulfonic acids and salts thereof, alkyl sulfonic acids and salts thereof, secondary amines and salts thereof, tertiary amines and salts thereof, quaternary ammonium salts, pyridines and salts thereof, carboxylic acids and salts thereof, binol and its derivatives, thioureas, amino acids, N-heterocyclic carbenes, triazolium salts, boranes, boronic acids, boronic esters, organoborates, oxazaborolidines and complexes thereof, phosphines, phosphine oxides, phosphoric acids, phospholane oxides, phosphoramides, selenoxides, amine oxides, triphosphazine, chincona alkaloid, sulphides, tetrazoles, falvin derivatives, carbamic acid ammonium salts, piperidines, silanes, trialkyl silyl halides and combinations thereof.

The organocatalyst may be selected from the group consisting of p-toluene sulfonic acid, tris(2,2,2-trifluoroethyl)borate, (R)-(−)-1,1′-binaphthyl-2,2′-diyl hydrogenphosphate, 4-dimethylaminopyridinium acetate, piperidine and phospholane oxides. Preferably, the organocatalyst is para-toluenesulfonic acid monohydrate. Preferably, the organocatalyst is 4-dimethylaminopyridinium acetate or p-toluene sulfonic acid.

The organocatalyst may be included in the resin composition in an amount of from 0.05-20% w/w based on the total weight of the resin composition. Preferably, the organocatalyst is included in the resin composition in an amount of from 1-15% w/w such as 2-14% w/w or 5-10% w/w, more preferably in an amount of from 6-12% w/w.

The catalyst of the present invention may include a photopolymerisable functional group. Accordingly, the catalyst may become chemically bound upon polymerisation.

The light-curable liquid resin composition may preferably comprise at least one (meth)acrylate, (meth)acrylamide, epoxide, vinyl ether, vinyl ester, vinyl sulfonate, styrene, N-vinylpyrrolidone, vinylcaprolactam and combinations thereof.

Preferably there is essentially no chemical alteration or degradation of the catalyst in terms of its catalytic functionality during its dispersal in the matrix and/or upon curing. In other words the catalytic performance of the catalyst is not adversely affected or is not significantly adversely affected by its dispersal in the matrix and/or upon curing. For example, catalyst performance may remain essentially the same, or at least 90%, preferably at least 95%, more preferably at least 99%, in comparison with performance of the free catalyst which is not dispersed in a matrix.

In the embodiment (applicable to all aspects of the invention) in which the catalyst is dispersed in a matrix, the term “dispersed” has its usual meaning, i.e. spread throughout the matrix, for example, spread essentially uniformly throughout the matrix. Preferably the dispersed catalyst may be held within the matrix by covalent, non-covalent or ionic bonds or interactions. More preferably the dispersed catalyst may be held within the matrix by non-covalent interactions.

In one embodiment of the invention, applicable to all aspects, the light-curable resin composition is free from or excludes onium salts. Preferably said composition is free from or excludes onium salts comprising a toluene sulfonate ion.

In another embodiment of the invention, applicable to all aspects, the catalyst is free from or excludes onium salts. More preferably, the catalyst is free from or excludes onium salts comprising toluene sulfonate anion.

### Optional Additives

The composition may further include at least one pigment or dye. Suitable pigments include white pigments, organic pigments, inorganic pigments, metal pigments and combinations thereof.

The composition may further include at least one stabiliser and/or at least one photoinhibitor. Examples of suitable photoinhibitors for use in the present invention include phenols, benzotriazoles and diazo compounds. In particular, the composition may contain a photoinhibitor selected from the group consisting of 4-methoxy phenol, Sudan I, 2-(hydroxyphenol)benzotriazole and 2-(2′-hydroxy-3′-tert-butyl-5′-methylphenyl)-5-chlorobenzotriazole. Preferably the photoinhibitor is 4-methoxyphenol. The inventors have found this photoinhibitor to be advantageous as it is colourless and acts as a possible point of attachment to the polymer chain.

The photoinhibitor may be included in the resin composition in an amount of from 0.01-2% w/w based on the total weight of the resin composition. Preferably, the photoinhibitor is included in the resin composition in an amount of from 0.05-0.5% w/w.

### Preferred Resin Compositions

In a preferred embodiment, applicable to all aspects of the invention, the light-curable resin composition comprises:
i) 0.1-3% w/w based on the total weight of the resin composition of a photoinitiator selected from bis(2,6-dimethoxybenzoyl)(2,4,4-trimethylpentyl)phosphine oxide, bis(2,4,6-trimethylbenzoyl)(2,4-dihexyloxyphenyl)phosphine oxide, bis(2,4,6-trimethyl-benzoyl)(4-ethoxyphenyl)phosphine oxide, bis(2,4,6-trimethylbenzoyl)phenylphosphine oxide or 2,4,6-trimethylbenzoyldiphenylphosphine oxide and the α-hydroxy ketone compound is selected from α-hydroxycyclohexyl phenyl ketone, 2,2-demiethoxyacetophenone, 1,1-dichloroacetophenone or 2-hydroxy-2-methyl-1-phenylpropan-1-one, a phosphine oxide, a titanocene, a thioxanthone, an α-hydroxyketone, a benzophenone derivative, diphenyl(2,4,6-trimethylbenzoyl)phosphine oxide, or combinations thereof;
ii) 40-99.85% w/w based on the total weight of the resin composition of at least one ethylenically unsaturated compound selected from 1,6-hexanedioldiacrylate, 2-(2-ethoxy)ethyl acrylate, 2-phenoxyethyl acrylate, isodecyl acrylate, ethoxylated-4-phenyl acrylate, 3,3,5-trimethyl cyclohexanol acrylate, iso octyl acylate, tridecyl acrylate, isobornyl acrylate, poly(ethylene glycol)diacrylate (Mn 200 to 400), polybutadiene diacrylate, bisphenol A propoxylate diglycidyl ether, isobornyl acrylate, poly(ethyleneglycol)diacrylate, bisphenol A ethoxylate diacrylate, and combinations thereof; and
iii) 0.05-20% w/w based on the total weight of the resin composition of a catalyst selected from copper(I) trifluoromethanesulfonate, copper(II) trifluoromethansulfonate, zinc(II) trifluoromethansulfonate, scandium(III) trifluoromethanesulfonate, palladium(II) acetate or palladium(II) chloride, (1,3-Bis(2,4,6-trimethylphenyl)-2-imidazolidinylidene)dichloro(phenylmethylene)(tricyclohexylphosphine)ruthenium, Tris(triphenylphosphine)rhodium(I) chloride, Bi s(triphenylphosphine)palladium(II) dichloride, Tetrakis(triphenylphosphine)palladium(0), Tris(dibenzylideneacetone)dipalladium(0), p-toluene sulfonic acid, tris(2,2,2-trifluoroethyl)borate, (R)-(−)-1,1′-binaphthyl-2,2′-diyl hydrogenphosphate, 4-dimethylaminopyridinium acetate, piperidine and phospholane oxides.

In another preferred embodiment equally applicable to all aspects of the invention, the light-curable liquid resin composition comprises:
(i) 0.1-3% w/w based on the total weight of the resin composition of diphenyl(2,4,6-trimethylbenzoyl)phosphine oxide;
(ii) 80-99.8% w/w based on the total weight of the resin composition of an ethylenically unsaturated compound selected from the group consisting of 1,6-hexanedioldiacrylate, 2-(2-ethoxy)ethyl acrylate, 2-phenoxyethyl acrylate, isodecyl acrylate, ethoxylated-4-phenyl acrylate, 3,3,5-trimethyl cyclohexanol acrylate, iso octyl acylate, tridecyl acrylate, isobornyl acrylate, poly(ethylene glycol)diacrylate (Mn 200 to 400);
(iii) 0.1-12% w/w based on the total weight of the resin composition of a catalyst selected from copper(I) trifluoromethanesulfonate, copper(II) trifluoromethansulfonate, zinc(II) trifluoromethansulfonate, scandium(III) trifluoromethanesulfonate, Tetrakis(triphenylphosphine)palladium(0), Tris(dibenzylideneacetone)dipalladium(0), p-toluene sulfonic acid, and 4-dimethylaminopyridinium acetate.

In another preferred embodiment, equally applicable to all aspects of the invention, the light-curable resin composition comprises or consists of:

| | Ethylenically | | | |
|---|---|---|---|---|
| | unsaturated | | | Optional |
| Composition | compound | Catalyst | Photoinitiator | photoinhibitor |
| pTsOH | Poly(ethylene | p-toluene sulfonic acid monohydrate | Diphenyl(2,4,6- | |
| | glycol) diacrylate | (10% w/w) | trimethylbenzoyl)phosphine oxide | |
| | (Mn 250) (89.5% w/w) | | (0.5% w/w) | |
| DMAP•AcOH | Poly(ethylene | 4-(dimethylamino)pyridin-1-ium | Diphenyl(2,4,6- | 4-methoxyphenol |
| | glycol) diacrylate | acetate (5% w/w) | trimethylbenzoyl)phosphine oxide | (0.1% w/w) |
| | (Mn 250) (94.4% w/w) | | (0.5% w/w) | |
| Cu₂OTf₂ | Poly(ethylene | Copper(I) trifluormethansulfonate (5% | Diphenyl(2,4,6- | |
| | glycol) diacrylate | w/w) | trimethylbenzoyl)phosphine oxide | |
| | (Mn 250) (93.53% w/w) | | (1.47% w/w) | |
| Sc(OTf)₃ | Poly(ethylene | Scandium(III) trifluormethansulfonate | Diphenyl(2,4,6- | |
| | glycol) diacrylate | (2.5% w/w) | trimethylbenzoyl)phosphine oxide | |
| | (Mn 250) (96.03% w/w) | | (1.47% w/w) | |
| TBD•AcOH | Poly(ethylene | Scandium(III) trifluormethansulfonate | Diphenyl(2,4,6- | |
| | glycol) diacrylate | (5% w/w) | trimethylbenzoyl)phosphine oxide | |
| | (Mn 250) (94.5% w/w) | | (0.5% w/w) | |
| Pd(PPh₃)₄ | Poly(ethylene | Tetrakis(triphenylphosphine) | Diphenyl(2,4,6- | |
| | glycol) diacrylate | palladium (0) (0.5% w/w) | trimethylbenzoyl)phosphine oxide | |
| | (Mn 250) (98.03% w/w) | | (1.47% w/w) | |

### Articles and Typical Applications

The articles of the invention may also be referred to herein as three-dimensional objects.

The use of three-dimensional printing allows one to create almost any possible shape, in addition to rapid prototyping. The structure, shape, size and surface area:volume ratio of the article to be formed are therefore not limited and can be determined depending on the end use. Examples of typical applications of the present invention include the production of magnetic stirrer bar holders, stirrers, reaction vessels and paddles. The 3D printed articles may also be used as inserts or stirrers in microwave reactors and cartridges for flow hydrogenation systems.

Articles according to the invention comprise a laminated core, which may suitably be manufactured as described hereinbefore. Articles according to the invention may consist essentially of said laminated core, or consist of said laminated core. Alternatively, articles according to the invention may include at least one additional outer layer, for example a coating, or a layer which has been surface-functionalised.

Coatings may suitably be applied using techniques known in the art, such as dipping, rolling, spray-drying.

Surface-functionalisation of the outer layer of the articles of the invention may be achieved using methods known in the art, where desirable or appropriate for a given reaction. In a preferred embodiment, applicable to all aspects of the invention, any surface-functionalisation or coatings to not adversely affect or do not significantly adversely affect the catalytic performance of the articles according to the invention.

One benefit of the articles provided by the current invention is their catalytic function. The catalyst(s) incorporated into the article are active and available for catalysis.

The organocatalyst impregnated articles of the present invention are suitable for use in any catalytic process in which a reactant mixture is contacted with the catalyst under conditions to effect a catalysed reaction.

The ability to impregnate a plastic with a catalyst has the potential to circumvent many separation/purification procedures involved in chemical synthesis, thereby saving resources and avoiding potential compatibility issues.

Preferably the article is a stirrer bar holder. The stirrer bar holder can be used to catalyse an organic reaction. The inventors have found that the article of the present invention can be used to catalyse a wide range of synthetically useful organic transformations, such as cross coupling, Friedel-Craft reactions, Mannich reactions, Catalytic Wittig reactions, Knovenagel condensation, asymmetric aldol reactions, conjugate addition of an aldehyde to an enone, for example. Suitable organic reactions depend on the particular catalyst(s) impregnated in the resin.

For example, when the catalyst impregnated in the resin is p-toluene sulfonic acid monohydrate, the stirrer bar can be used to catalyse the Mannich reaction, Fischer Indole synthesis, deprotection of tetrahydropyran ethers and Hantzsch dihydropyridine synthesis. When the catalyst impregnated in the resin is (R)-(−)-1,1′-binaphthyl-2,2′-diyl hydrogenphosphate, the reaction may be selected from the Pictet-Spengler reaction, asymmetric Mannich reaction, Friedel-Crafts and reductive amination. When the catalyst impregnated in the resin is tris(2,2,2-trifluoroethyl)borate, the reaction may be an amidation reaction. Furthermore, the catalyst impregnated in the resin is R)-(−)-1,1′-binaphthyl-2,2′-diyl hydrogenphosphate, the 3D printed article may be used for chiral resolution and as a chiral acid source. When the catalyst impregnated in the resin is 4-dimethylaminopyridinium acetate, the reaction may be an acylation. When the catalyst impregnated in the resin is a phospholane oxide, the reaction may be a catalytic Wittig reaction. When the catalyst impregnated in the resin is a copper (I) salt such as copper(I) trifluormethansulfonate, the reaction may be a Huisgen cycloaddition. When the catalyst is a zinc complex such as zinc trifluoromethanesulfonate, the reaction may be a vinylogous amide synthesis. When the catalyst is a scandium salt such as scandium trifluoromethanesulfonate, the reaction may be a benzimidazole synthesis. When the catalyst is triazabicyclodecene-acetic acid, the reaction may be amide synthesis. When the catalyst is a palladium complex such as tetrakis(triphenylphosphine) palladium(0), the reaction may be Suzuki coupling.

The inventors have also found that the surface area of the 3D printed article (e.g. stirrer bar holder) can be modified to suit the particular reaction. For example, the surface area of the stirrer bar holder can be modified in order to optimise the rate of reaction. In particular, when the 3D printed article is used to catalyse a Mannich reaction, a 3D printed article with a surface area between 950 and 1600 mm², preferably 1100 and 1500 mm², more preferably 1250 to 1450 mm², may be advantageous (reaction of benzaldehyde, aniline and cyclohexanone in 4 ml of ethanol on a 2 mmol scale). However, a person skilled in the art will appreciate that the surface area will depend on the scale that the reaction is carried out on, as well as the specific catalytic requirements of each reaction.

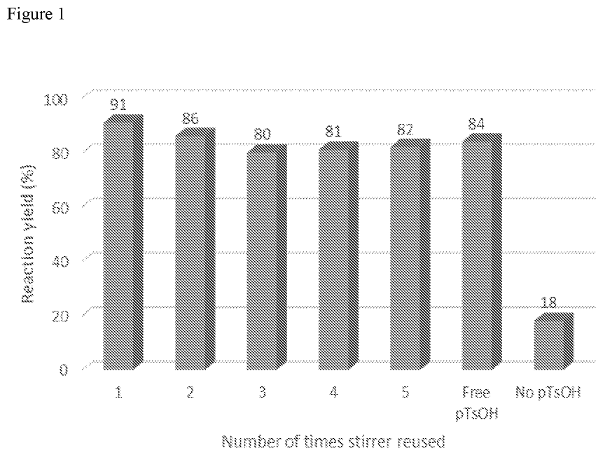

The stirrer bead (and therefore the catalyst) can be easily removed from the reaction mixture thereby circumventing the need for additional process steps to remove the catalyst. Furthermore, as demonstrated in FIG. 1, the catalyst can be reused with only a small reduction in activity. Accordingly, the articles of the present invention are very useful for the production of valuable chemical products or intermediates, such as, those within the pharmaceutical, agrochemical and other fine chemical industries.

### EXAMPLES

### Preparation Example 1

### Preparation of Catalyst-Doped Light-Curable Liquid Resin

Freshly ground p-toluene sulfonic acid monohydrate (5% w/v) and diphenyl (2,4,6-trimethylbenzoyl)phosphine oxide (2% w/w) were dissolved in isobornyl acrylate (33% w/w) in the absence of light with the aid of sonification. Trimethylolpropane triacrylate (15% w/w) and bisphenol A ethoxylate diacrylate (50% w/w) were added and the mixture stirred for 15 h. The photopolymerisable resin was poured into the tray of a Formlabs Form 1+ SLA three-dimensional printer.

### Design Software

The stirrer bar holders and other articles were designed using the freeware Tinkercad (www.tinkercad.com), which is able to export models in .STL file format for use with a three-dimensional printer.

### Device Design

The stirrer bar holder design was based upon a commercial overhead stirrer (www.silverson.com/us/products/ultramix-mixers) with a large surface area which, when spun at high speeds, would cause 1) a high flow of liquid over the surface of the stirrer and 2) high turbulence to ensure efficient mixing. A slot to hold a 10 mm×3 mm magnetic flea was added.

### Device Fabrication

The photopolymerisable resin was poured into the tray of the Formlabs Form 1+ SLA printer. The .STL file of the model was loaded using the PreForm software for use with a Formlabs 3D printer. The stirrer bar holders were printed with a layer height of 0.1 mm using the Clear02 resin setting. After printing, the articles were removed, soaked in isopropanol for 10 minutes and left to dry and finish curing in natural light for 24 hours. A magnetic flea (10 mm×3 mm) was added and to secure it, additional catalyst-doped photopolymerisable resin was added and the articles placed in natural sunlight for 24 hours to cure the resin. The articles were finally rinsed with isopropanol and dried.

### Preparation Example 1a

### Preparation of Catalyst-Doped Light-Curable Liquid Resin

Freshly ground p-toluene sulfonic acid monohydrate (10% w/w) and diphenyl(2,4,6-trimethylbenzoyl)phosphine oxide (0.5% w/w) were dissolved in poly(ethylene glycol) diacrylate (Mn250, obtained from Sigma-Aldrich). The photopolymerisable resin was poured into the tray of Formlabs Form 1+ SLA 3D printer.

Design Software The stirrer bar holders and other articles were designed using the freeware Tinkercad (www.tinkercad.com), which is able to export models in .STL file format for use with a three-dimensional printer.

### Device Design

The stirrer bar holder design was based upon a commercial overhead stirrer (www.silverson.com/us/products/ultramix-mixers) with a large surface area which, when spun at high speeds, would cause 1) a high flow of liquid over the surface of the stirrer and 2) high turbulence to ensure efficient mixing. A slot to hold a 10 mm×3 mm magnetic flea was added.

### Device Fabrication

The photopolymerisable resin was poured into the tray of the Formlabs Form 1+ SLA printer. The .STL file of the model was loaded using the PreForm software for use with a Formlabs 3D printer. The stirrer bar holders were printed with a layer height of 0.1 mm using the Clear02 resin setting. After printing, the articles were removed, soaked in isopropanol for 10 minutes and left to dry and finish curing in natural light for 24 hours. A magnetic flea (10 mm×3 mm) was added and to secure it, additional catalyst-doped photopolymerisable resin was added and the articles placed in natural sunlight for 24 hours to cure the resin. The articles were finally rinsed with isopropanol and dried.

### Preparation Example 2

### Preparation of DMAP.AcOH Catalyst and Catalyst-Doped Light Curable Liquid Resin

Acetic acid (1.889 mL, 33.0 mmol) was added slowly to a stirred solution of N,N-dimethylpyridin-4-amine (3.67 g, 30 mmol) in CH₂Cl₂ (30 mL) at room temperature. The reaction was left to stand for 15 min then concentrated in vacuo to ca 5 mL. Et₂O (50 mL) was added and the colourless precipitate was filtered in vacuo, washed with Et₂O and dried under high vacuum. A 2nd crop of crystals were recovered from the filtrate. The spectral data are in agreement with the literature.

¹H NMR (400 MHz, CDCl₃) δ 2.07 (s, 3H), 3.07 (s, 6H), 6.55 (m, 2H), 8.25 (d, J=6.6 Hz, 2H), 15.61 (br. s, 1H); ¹³C NMR (100 MHz, CDCl₃) δ 22.4, 39.3, 106.5, 145.8, 155.4, 176.0

DMAP.AcOH (5% w/w), diphenyl(2,4,6-trimethylbenzoyl)phosphine oxide (0.5% w/w) and 4-methoxyphenol (0.1% w/w) were dissolved in poly(ethylene glycol) diacrylate (Mn250). The photopolymerisable resin was poured into the tray of Formlabs Form 1+ SLA 3D printer.

Device design and fabrication identical as in preparation Examples 1 and 1a

### Comparative Example 1

### Preparation of Catalyst-Doped Light-Curable Liquid Resin

Freshly ground p-toluene sulfonic acid monohydrate (5% w/v) and diphenyl (2,4,6-trimethylbenzoyl)phosphine oxide (2% w/w) were dissolved in isobornyl acrylate (33% w/w) in the absence of light with the aid of sonification. Trimethylolpropane triacrylate (15% w/w) and bisphenol A ethoxylate diacrylate (50% w/w) were added and the mixture stirred for 15 h.

### Preparation of Stirrer Bar

A magnetic stirrer was placed within the resin impregnated with pTsOH inside a disposable syringe and polymerised by exposure to natural lighting. The stirrer bar was used to catalyse a Mannich reaction (the reaction of aniline, benzaldehyde and acetone in water).

Degradation of the impregnated stirrer was observed.

### Examples of Use of Catalytically Active 3D Printed Stirrers

### 1) Organic Synthesis—Mannich Reaction

The catalytically active stirrer bar holder containing a magnetic flea was added to a 25 ml round bottom flask along with ethanol (4 mL) and placed above a stirrer hotplate. With the stirrer at maximum speed, benzaldehyde (0.20 mL, 2 mmol), aniline (0.18 mL, 2 mmol) and cyclohexanone (0.31 mL, 3 mmol) were added successively and the reaction was monitored by thin layer chromatography. The starting materials were consumed after 5 hours and an off white precipitate had formed. Deionised water (8 mL) was added and stirring was stopped. The precipitate was filtered in vacuo, washed with deionised water/ethanol (2:1) and dried to afford 2-(phenyl(phenylamino)methyl)cyclohexanone as colourless solid (508 mg, 91%). The spectral data are in agreement with the literature.

### Syn/Anti 33:67

¹H NMR (400 MHz, CDCl₃) δ 1.60-2.06 (m, 6H), 2.31-2.36 (m, 1H), 2.42-2.46 (m, 1H), 2.74-2.79 (m, 1H), 4.63 (d, J=7.1 Hz, 0.67H), 4.69 (brs, 1H), 4.81 (d, J=4.3 Hz 0.33H), 6.52-6.57 (m, 1H), 7.05-7.10 (m, 2H), 7.20-7.24 (m, 1H), 7.28-7.33 (m, 2H), 7.53-7.39 (m, 2H); ¹³C NMR (100 MHz, CDCl₃) 6 (anti) 23.7, 27.9, 31.3, 41.8, 57.5, 58.0, 113.6, 117.5, 127.2, 127.3, 128.5, 129.1, 141.6, 147.2, 212.9; (syn) 24.9, 27.0, 26.7, 42.4, 56.6, 57.2, 114.1, 117.7, 127.0, 127.5, 128.4, 129.0, 141.5, 147.5, 211.3.

### Examples 2-12

The stirrer bar produced in Preparation Example 1 was used to catalyse a Mannich reaction between a variety of aldehydes and anilines. As demonstrated in Table 1, high yields of the Mannich product were obtained when a stirrer bar produced according to the present invention was used to catalyse the reaction.

It is noted that the yield of the Mannich product was higher when the impregnated stirrer was used to catalyse the reaction, when compared with the yield of the Mannich product obtained when free, dissolved para-toluene sulfonic acid was used to catalyse the reaction (comparative Example 2).

TABLE 1
This table shows the precentage yield of the Mannich product obtained when the
3D printed catalytic stirrer of the present invention is used to catalyse the reaction

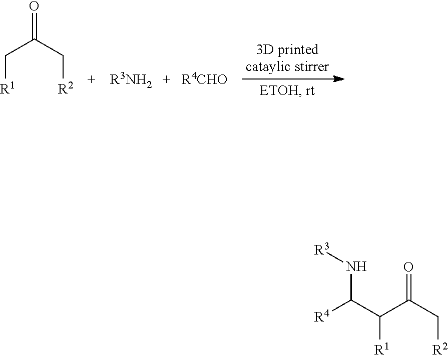

| | Ketone | | Amine | Aldehyde | Time | Yield |
|---|---|---|---|---|---|---|
| Example | R¹ | R² | R³ | R⁴ | (hr) | (%) |
| 1 | —(CH₂)₃— | | Ph | Ph | 5 | 91 |
| 2 | —(CH₂)₃— | | Ph | 4-NO₂C₆H₄ | 5 | 89 |
| 3 | —(CH₂)₃— | | Ph | 4-MeOC₆H₄ | 5 | 71 |
| 4 | —(CH₂)₃— | | Ph | 4-FC₆H₄ | 5 | 85 |
| 5 | —(CH₂)₃— | | Ph | 4-ClC₆H₄ | 5 | 70 |
| 6 | —(CH₂)₃— | | 4-FC₆H₄ | Ph | 5 | 84 |
| 7 | —(CH₂)₃— | | 4-CF₃C₆H₄ | Ph | 5 | 60 |
| 8 | —(CH₂)₃— | | 4-CF₃OC₆H₄ | Ph | 5 | 87 |
| 9 | —(CH₂)₃— | | 4-ClC₆H₄ | Ph | 5 | 72 |
| 10 | —(CH₂)₃— | | 4-CF₃OC₆H₄ | 4-NO₂C₆H₄ | 5 | 91 |
| 11 | Ph | H | Ph | Ph | 24 | 52 |
| 12^{a} | H | H | Ph | Ph | 3 | 65 |

| | | | | | |
|---|---|---|---|---|---|
| Comparative | —(CH₂)₃— | Ph | Ph | 24 | 51 |
| Example 1 | | | | | |
| Comparative | —(CH₂)₃— | Ph | Ph | 5 | 84 |
| Example 2 | | | | | |

Conditions: 1.5 equiv. ketone, 1 equiv. amine, 1 equiv. aldehyde, EtOH (0.5 M), rt.
^{a}ketone (3 eq.)

### 2) Organic Synthesis—4 Component Synthesis of Dihydropyridines

To a 25 mm test tube was added benzaldehyde (0.182 ml, 1.783 mmol), 5,5-dimethylcyclohexane-1,3-dione (0.250 g, 1.783 mmol), ethyl 3-oxobutanoate (0.228 ml, 1.783 mmol), ammonium acetate (0.137 g, 1.783 mmol) and pTsOH doped stirrer bead were added to ethanol. The reaction was stirred at maximum speed for 4 hours. The reaction mixture was then concentrated in vacuo and the residue was purified by flash column chromatography (3:2 Hexane:EtOAc) to afford ethyl 2,7,7-trimethyl-5-oxo-4-phenyl-1,4,5,6,7,8-hexahydroquinoline-3-carboxylate (0.424 g, 1.249 mmol, 70.0% yield) as a yellow solid. The spectral data are in agreement with the literature.

mp: 212-214° C.

¹H NMR (400 MHz, CDCl₃) 7.28-7.34 (2H, m), 7.19 (2H, t, J 7.6), 7.06-7.12 (1H, m), 6.81 (1H, br. s.), 5.06 (1H, s), 4.07 (2H, q, J 7.1), 2.33 (3H, s), 2.11-2.32 (4H, m), 1.20 (3H, t, J 7.1), 1.06 (3H, s), 0.93 (3H, s); ¹³C NMR (101 MHz, CDCl₃) 195.4 (CO), 167.4 (CO), 147.9 (C), 147.0 (C), 143.3 (C), 128.0 (CH), 127.9 (CH), 126.0 (CH), 112.2 (C), 106.1 (C), 59.8 (CH2), 50.7 (CH2), 41.1 (CH2), 36.5 (CH3), 32.7 (C), 29.4 (CH3), 27.1 (CH), 19.4 (CH3), 14.2 (CH3)

### 3) Organic Synthesis—Catalytic Acylation of an Alcohol

The DMAP.AcOH doped stirrer bead was added to a 25 mL round bottom flask, equipped with a condenser, along with phenol (188 mg, 2 mmol) and toluene (4 mL). With the stirrer at maximum speed, acetic anhydride (0.21 mL, 2.2 mmol) was added slowly via syringe. The reaction was heated at reflux for 6 h then cooled to room temperature and filtered. The filtrate was concentrated in vacuo and purified by flash column chromatography (20:1 Hexane:EtOAc) to afford phenyl acetate as a colourless oil (226 mg, 83%). The spectral data are in agreement with the literature.

¹H NMR (400 MHz, CDCl₃) δ 2.31 (s, 3H), 7.09-7.11 (m, 2H), 7.22-7.26 (tt, J=7.3, 1.3 Hz, 1H), 7.37-7.41 (m, 2H); ¹³C NMR (100 MHz, CDCl₃) δ 21.1, 121.6, 125.8, 129.4, 150.7, 169.5

### Optimised Resin Formulation for 3D Printed Catalyst Impregnated Stirrers

Catalyst (x % w/w) and diphenyl(2,4,6-trimethylbenzoyl) phosphine oxide (x % w/w) were dissolved in poly(ethylene glycol) diacrylate (Mn 250). When dissolution was complete the photopolymerizable resin was poured into the tray of a Formlabs Form 1+ SLA 3D printer. The devices were fabricated as discussed in preparation examples 1 and 1a and fitted with the appropriate magnetic stirrer.

### Example 13—Use of a Copper(I) Trifluormethansulfonate Impreganted Stirrer—Huisgen Cycloaddition

A 25 mL round bottom flask containing a Cu₂OTf₂ impregnated 3D printed stirrer (loading 5%) was charged with phenyl acetylene (0.110 mL, 1 mmol), t-butanol (1 mL) and water (1 mL) and benzyl azide (0.125 mL, 1 mmol) was added and the reaction stirred vigorously. After 1 h the reaction mixture was filtered and washed with DI water. The solid material was isolated by dissolving in EtOAc and filtering off the stirrer. The filtrate was dried (MgSO₄), filtered and concentrated in vacuo. The crude material was purified by flash column chromatography (30:1 hexanes:EtOAc) to afford the desired triazole product as a colourless solid (89%).

1H NMR (400 MHz, CDCl3); δ 5.59 (s, 2H), 7.25-7.33 (m, 3H), 7.40-7.57 (m, 5H), 7.68 (s, 1H), 7.81-7.83 (d, 2H). 13C NMR (100 MHz, CDCl3); δ 54.2, 119.5, 125.7, 128.1, 128.1, 128.8, 129.0, 129.2, 130.6, 134.7, 148.2.

### Example 14—Use of a p-Toluene Sulfonic Acid Impregnated Stirrer—Oxazole Synthesis

2-amino-5-methylphenol (1.50 g, 12.18 mmol) was dissolved in trimethoxymethane (20 mL, 260 mmol) under an atmosphere of nitrogen and using TsOH impregnated stirrer bead and heated to 105° C. After 20 h the reaction was cooled to room temperature, the stirrer removed and the reaction mixture concentrated in vacuo. The desired 6-methylbenzo[d]oxazole was isolated as colourless solid (88%).

1H NMR (400 MHz, CDCl3) δH ppm=8.04 (1H, s, Ar—H), 7.68 (1H, d, J=8.1 Hz, Ar—H), 7.43-7.37 (1H, m, Ar—H), 7.25-7.15 (1H, m, Ar—H), 2.52 (3H, s, CH3)

### Example 15—Use of a Zinc Trifluoromethanesulfonate Impregnated Stirrer—Vinylogous Amide Synthesis

A 50 mL round bottom flask containing a Zn(OTf)₂ impregnated 3D printed stirrer was charged with ethyl acetoacetate (0.286 g, 2.2 mmol), aniline (0.186 g, 2 mmol) and ethanol (4 mL) and the reaction stirred vigorously. After 2.5 h the stirrer was removed and washed with ethanol and the reaction mixture concentrated in vacuo. The crude residue was purified by flash column chromatography (hexane/EtOAc) to afford the desired vinylogous amide as a pale yellow oil (60%).

1H NMR (400 MHz, Chloroform-d) δ 10.38 (s, 1H, NH), 7.35-7.29 (m, 2H, ArH), 7.18-7.12 (m, 1H, ArH), 7.11-7.06 (m, 2H, ArH), 4.69 (d, J=0.8 Hz, 1H, COCH), 4.15 (q, J=7.1 Hz, 2H, OCH2CH3), 2.00 (d, J=0.6 Hz, 3H, NHCCH3), 1.29 (t, J=7.1 Hz, 3H, OCH2CH3).

### Example 16—Use of a Scandium Trifluoromethanesulfonate Impregnated Stirrer—Benzimidazole Synthesis

A 50 mL round bottom flask containing a Sc(OTf)₃ impregnated 3D printed stirrer was charged with benzene-1,2-diamine (0.065 g, 0.6 mmol), benzaldehye (0.106 g, 1 mmol) and ethanol (5 mL) and the reaction stirred vigorously at 80° C. for 8 hours. The reaction was then cooled to room temperature, the stirrer removed and washed with ethanol and the mixture concentrated in vacuo. The crude residue was purified by flash column chromatography (hexane/EtOAc) to afford the desired benzimidazole as a colourless solid (74%).

1H NMR (500 MHz, Chloroform-d) δ 7.88 (d, J=8.0 Hz, 1H), 7.71-7.68 (m, 2H), 7.50-7.42 (m, 3H), 7.35-7.27 (m, 4H), 7.25-7.18 (m, 2H), 7.13-7.09 (m, 2H), 5.46 (s, 2H).

### Example 17—Use of a Triazabicyclodecene-Acetic Acid Impregnated Stirrer—Amide Synthesis

A 25 mL round bottom flask containing a TBD.AcOH impregnated 3D printed stirrer was charged with methyl benzoate (0.189 mL, 1.5 mmol), benzylamine (0.197 mL, 1.8 mmol) and THF (1.5 mL) and the reaction stirred vigorously at reflux for 8 h 30. The reaction was then cooled to room temperature and left to stand overnight. The stirrer was removed and the reaction mixture concentrated in vacuo. The crude residue was purified by flash column chromatography (4:1 hexane/EtOAc) to afford benzylbenzamide as a colourless solid (26%).

### Example 18—Use of a Tetrakis(Triphenylphosphine) Palladium(0) Impregnated Stirrer—Suzuki Coupling

A 25 mL round bottom flask containing a Pd(PPh₃)₄ impregnated 3D printed stirrer was charged with phenylboronic acid (0.071 g, 0.586 mmol), 4-iodoacetophenone (0.131 g, 0.532 mmol), sodium carbonate (0.113 g, 1.065 mmol), ethanol (8 mL) and water (2 mL) and the reaction stirred vigorously at 65° C. for 18 h. The reaction was then cooled to room temperature and the stirrer was removed and washed with CH₂Cl₂. The crude mixture was partitioned between water (15 mL) and CH₂Cl₂ (15 mL) and the aqueous phase extracted with CH₂Cl₂ (3×15 mL). The combined organic fractions were dried (MgSO₄), filtered and evaporated in vacuo to afford 1-([1,1′-biphenyl]-4-yl)ethanone (0.101 g, 0.515 mmol, 97%)

### Reusability

The reusability of the stirrer bar obtained in Preparation Example 1 was evaluated. The results are shown in FIG. 1 and the table below. As demonstrated in this FIGURE, the reaction yield remained high after the stirrer bar was used five times. Accordingly, the stirrers of the present invention also show excellent reusability.

| Number of times stirrer used | Reaction yield |
|---|---|
| 1 | 91 |
| 2 | 86 |
| 2 | 80 |
| 4 | 81 |
| 5 | 82 |
| Comparative example: Free pTsOH | 84 |
| Comparative example: No pTsOH | 18 |

### Solvent Resistance Tests

Cubes of 3D printed PEGDA were immersed in a range of organic solvents for 24 hours. Articles showed low swelling (<3% height difference). Articles also showed good resistance to 6 M HCl, acetic acid and triethylamine (<3% height difference) as well as refluxing toluene and tetrahydrofuran (<3% height difference).

It was previously thought that SLA printed articles are not chemically resistant (see Christie, Lab Chip, 2013, 13, 4583). However, the inventors of the present invention have found that the 3D printed articles made from the light curable resin described herein show good solvent resistance. As demonstrated in Comparative Example 1, these surprising solvent resistance properties are not replicated when an article is not 3D printed.

### PREFERRED EMBODIMENTS

Preferred embodiments of the invention include the following:

### Embodiment #1

A method for producing a three-dimensional object, the method comprising:
   a) preparing a light-curable liquid resin composition comprising:
      i) a photoinitiator;
      ii) at least one ethylenically unsaturated compound; and
      iii) a catalyst selected from the group consisting of an organocatalyst, a metal salt and a metal-ligand complex, and
   b) selectively curing at least one portion of the light-curable liquid resin by exposure to electromagnetic radiation.

### Embodiment #2

The method of embodiment 1, wherein the at least one portion of the light-curable liquid resin is selectively cured based on instructions provided in an electronic file.

### Embodiment #3

The method of embodiment 1 or embodiment 2, wherein, after step (b), the cured portion of the light-curable liquid resin is moved, by a distance corresponding to at least the thickness of the cured portion, away from the surface of the light-curable liquid resin, before a further portion of the light-curable liquid resin is cured and adhered to the previously cured portion.

### Embodiment #4

The method of embodiment 3, wherein the method further comprises curing sequential layers of the light-curable liquid resin until the production of the object is complete.

### Embodiment #5

The method according to any of the preceding embodiments, wherein the photoinitiator is a free radical photoinitiator, a cationic photoinitiator or a combination thereof.

### Embodiment #6

The method according to any of the preceding embodiments, wherein the photoinitiator is selected from the group consisting of a phosphine oxide, an α-hydroxyketone, a benzophenone derivative, a titanocene, a thioxanthone and an onium salt and combinations thereof.

### Embodiment #7

The method to embodiment 6, wherein the photoinitiator is diphenyl(2,4,6-trimethylbenzoyl)phosphine oxide.

### Embodiment #8

The method according to any of the preceding embodiments, wherein the photoinitiator is present in the light-curable liquid resin composition in an amount of from 0.01 to 6% w/v, preferably 0.3-0.7% w/v, based on the total volume of the resin composition.

### Embodiment #9

The method according to any of the preceding embodiments, wherein the ethylenically unsaturated compound is at least one (meth)acrylate, (meth)acrylamide, epoxide, vinyl ether, vinyl ester, vinyl sulfonate, styrene, N-vinylpyrrolidone, vinylcaprolactam and combinations thereof.

### Embodiment #10

The method according to embodiment 9, wherein the ethylenically unsaturated compound is selected from at least one of 1,6-hexanedioldiacrylate, 2-(2-ethoxy)ethyl acrylate, 2-phenoxyethyl acrylate, isodecyl acrylate, ethoxylated-4-phenyl acrylate, 3,3,5-trimethyl cyclohexanol acrylate, iso octyl acylate, tridecyl acrylate, isobornyl acrylate, poly(ethylene glycol)diacrylate, polybutadiene diacrylate, bisphenol A propoxylate diglycidyl ether and combinations thereof.

### Embodiment #11

The method according to embodiment 10, wherein the ethylenically unsaturated compound is selected from at least one of isobornyl acrylate, poly(ethyleneglycol)diacrylate, bisphenol A ethoxylate diacrylate and combinations thereof.

### Embodiment #12

The method according to any of the preceding embodiments, wherein the ethylenically unsaturated compound is poly(ethylene glycol)diacrylate and the photoinitiator is diphenyl(2,4,6-trimethylbenzoyl)phosphine oxide.

### Embodiment #13

The method according to any of the preceding embodiments, wherein the liquid resin composition further comprises a cross-linker.

### Embodiment #14

The method according to embodiment 13, wherein the cross-linker is a (meth)acrylate or a vinyl ether.

### Embodiment #15

The method according to embodiment 14, wherein the cross-linker is trimethylolpropane triacrylate.

### Embodiment #16

The method according to any of the preceding embodiments, wherein the catalyst is an organocatalyst.

### Embodiment #17

The method according to embodiment 16, wherein the organocatalyst is selected from the group consisting of p-toluene sulfonic acid, tris(2,2,2-trifluoroethyl)borate, (R)-(−)-1,1′-binaphthyl-2,2′-diyl hydrogenphosphate, 4-dimethylaminopyridinium acetate, piperidine and phospholane oxides.

### Embodiment #18

The method according to embodiment 17, wherein the organocatalyst is p-toluene sulfonic acid monohydrate.

### Embodiment #19

The method according to any of the preceding embodiments, wherein the organocatalyst is present in the light-curable liquid resin composition in an amount of from 1 to 15% w/v.

### Embodiment #20

The method according to any of the preceding embodiments, wherein the light-curable liquid resin composition further comprises a photoinhibitor.

### Embodiment #21

The method according to embodiment 20, wherein the photoinhibitor is selected from the group consisting of 4-methoxy phenol, Sudan I, 2-(hydroxyphenol)benzotriazole and 2-(2′-hydroxy-3′tert-butyl-5′-methylphenyl)-5-chlorobenzotriazole.

### Embodiment #22

The method according to embodiments 20 or 21, wherein the photoinhibitor is present in the light-curable liquid resin composition in an amount of from 0.01 to 2% w/w, preferably 0.05-0.5% w/w.

### Embodiment #23

The method of any of the preceding embodiments, wherein the three-dimensional object is selected from the group consisting of a magnetic stirrer bar holder, a stirrer, a reaction vessel, a paddle a cartridge for flow hydrogenation systems, an insert for a microwave reactor and a stirrer for a microwave reactor.

### Embodiment #24

The method of embodiment 23, wherein the three-dimensional object is a magnetic stirrer bar holder.

### Embodiment #25

A three-dimensional object obtained or obtainable by the process of any of embodiments 1 to 24.

### Embodiment #26

Use of the three-dimensional object of embodiment 25 to catalyse a chemical reaction.

### Embodiment #27

The use of embodiment 26, wherein the catalyst is p-toluene sulfonic acid monohydrate and the chemical reaction is the Mannich reaction.

Particularly preferred embodiments of the invention include the following:

### Embodiment #28

A laminated article comprising multiple layers, each layer comprising the cured product of a light-curable liquid resin composition comprising:
   i) a photoinitiator;
   ii) at least one ethylenically unsaturated compound; and
   iii) a catalyst selected from the group consisting of an organocatalyst, a metal salt and a metal-ligand complex.

### Embodiment #29

A laminated article comprising multiple layers, each layer comprising a catalyst selected from the group consisting of an organocatalyst, a metal salt and a metal-ligand complex, wherein said catalyst is dispersed in a matrix; said matrix being the cured product of a light-curable liquid resin composition comprising:
   i) a photoinitiator; and
   ii) at least one ethylenically unsaturated compound.

### Embodiment #30

A method for producing a laminated article, said method comprising:

a) preparing a light-curable liquid resin composition comprising:
i) a photoinitiator;
ii) at least one ethylenically unsaturated compound; and
iii) a catalyst selected from the group consisting of an organocatalyst, a metal salt and a metal-ligand complex;
   b) curing at least one portion of the light-curable liquid resin by exposure to electromagnetic radiation; and
   c) repeating step b) to form an article comprising successive layers of cured resin.

### Embodiment #31

A method for producing an article, the method comprising:
a) preparing a light-curable liquid resin composition comprising:
   i) a photoinitiator;
   ii) at least one ethylenically unsaturated compound; and
   iii) a catalyst selected from the group consisting of an organocatalyst, a metal salt and a metal-ligand complex, and
b) selectively curing at least one portion of the light-curable liquid resin by exposure to electromagnetic radiation.

### Embodiment #32

The method according to embodiment 30 or 31 wherein step (b) is performed by means of a process comprising or consisting of three-dimensional printing, preferably vat polymerisation three-dimensional printing, more preferably stereolithography, continuous liquid interface production or continuous liquid interphase printing.

### Embodiment #33

The method of any of embodiments 30 to 32, wherein the at least one portion of the light-curable liquid resin is selectively cured based on instructions provided in an electronic file.

### Embodiment #34

The method of any of embodiments 30 to 33, wherein, after step (b), the cured portion of the light-curable liquid resin is moved, by a distance corresponding to at least the thickness of the cured portion, away from the surface of the light-curable liquid resin, before a further portion of the light-curable liquid resin is cured and adhered to the previously cured portion.

### Embodiment #35

The method of any of embodiments 30 to 34, wherein the method further comprises curing sequential layers of the light-curable liquid resin until the production of the article is complete.

### Embodiment #36

The article or method according to any of the preceding embodiments, wherein the photoinitiator is a free radical photoinitiator, a cationic photoinitiator or a combination thereof.

### Embodiment #37

The article or method according to any of the preceding embodiments, wherein the photoinitiator is selected from the group consisting of a phosphine oxide, an α-hydroxyketone, a benzophenone derivative, a titanocene, a thioxanthone and an onium salt and combinations thereof; preferably, wherein the photoinitiator is diphenyl(2,4,6-trimethylbenzoyl)phosphine oxide.

### Embodiment #38

The article or method according to any of the preceding embodiments, wherein the photoinitiator is present in the light-curable liquid resin composition in an amount of from 0.01 to 6% w/w, preferably 0.3-2% w/w, for example 1-2% w/w, based on the total volume of the resin composition.

### Embodiment #39

The article or method according to any of the preceding embodiments, wherein the ethylenically unsaturated compound comprises or consists of at least one (meth)acrylate, (meth)acrylamide, epoxide, vinyl ether, vinyl ester, vinyl sulfonate, styrene, N-vinylpyrrolidone, vinylcaprolactam and combinations thereof; preferably wherein the ethylenically unsaturated compound is selected from at least one of 1,6-hexanedioldiacrylate, 2-(2-ethoxy)ethyl acrylate, 2-phenoxyethyl acrylate, isodecyl acrylate, ethoxylated-4-phenyl acrylate, 3,3,5-trimethyl cyclohexanol acrylate, iso octyl acylate, tridecyl acrylate, isobornyl acrylate, poly(ethylene glycol)diacrylate, polybutadiene diacrylate, bisphenol A propoxylate diglycidyl ether and combinations thereof; more preferably wherein the ethylenically unsaturated compound is selected from at least one of isobornyl acrylate, poly(ethyleneglycol)diacrylate, bisphenol A ethoxylate diacrylate and combinations thereof; most preferably wherein the ethylenically unsaturated compound is poly(ethylene glycol)diacrylate and the photoinitiator is diphenyl(2,4,6-trimethylbenzoyl)phosphine oxide.

### Embodiment #40

The article or method according to any of the preceding embodiments, wherein the ethylenically unsaturated compound is present in the light-curable liquid resin composition in an amount of greater than 30% w/w, preferably 40-99% w/w, based on the total weight of the resin composition.

### Embodiment #41

The article or method according to any of the preceding embodiments, wherein the liquid resin composition further comprises a cross-linker; preferably wherein the cross-linker is a (meth)acrylate or a vinyl ether; more preferably wherein the cross-linker is trimethylolpropane triacrylate.

### Embodiment #42

The article or method according to any of the preceding embodiments, wherein the catalyst is an organocatalyst.

### Embodiment #43

The article or method according to embodiment 42, wherein the organocatalyst is selected from the group consisting of p-toluene sulfonic acid, tris(2,2,2-trifluoroethyl)borate, (R)-(−)-1,1′-binaphthyl-2,2′-diyl hydrogenphosphate, 4-dimethylaminopyridinium acetate, piperidine and phospholane oxides; preferably wherein the organocatalyst is p-toluene sulfonic acid monohydrate.

### Embodiment #44

The article or method according to any of the preceding embodiments, wherein the catalyst is present in the light-curable liquid resin composition in an amount of from 1 to 15% w/w.

### Embodiment #45

The article or method according to any of the preceding embodiments, wherein the light-curable liquid resin composition further comprises a photoinhibitor; preferably wherein the photoinhibitor is selected from the group consisting of 4-methoxy phenol, Sudan I, 2-(hydroxyphenol)benzotriazole and 2-(2′-hydroxy-3′tert-butyl-5′-methylphenyl)-5-chlorobenzotriazole.

### Embodiment #46

The article or method according to embodiment 45, wherein the photoinhibitor is present in the light-curable liquid resin composition in an amount of from 0.01 to 2% w/w, preferably 0.05-0.5% w/w.

### Embodiment #47

The article or method of any of the preceding embodiments, wherein the article is selected from the group consisting of a magnetic stirrer bar holder, a stirrer, a reaction vessel, a paddle a cartridge for flow hydrogenation systems, an insert for a microwave reactor and a stirrer for a microwave reactor; preferably wherein the article is a magnetic stirrer bar holder.

### Embodiment #48

The method according to any of embodiments 30 to 47, wherein said article is a laminated article according to embodiment 27 or 28.

### Embodiment #49

An article obtained or obtainable by the method according to any of embodiments 30 to 49.

### Embodiment #50

A kit for catalysing a chemical reaction comprising:

(i) the article according to any of embodiments 28 to 49, being a magnetic stirrer bar holder; and
(ii) a magnetic stirrer bar.

### Embodiment #51

Use of the article according to any of embodiments 28 to 49 to catalyse a chemical reaction.

### Embodiment #52

The use of embodiment 51, wherein the catalyst is p-toluene sulfonic acid monohydrate and the chemical reaction is the Mannich reaction.

### Embodiment #53

The use of embodiment 52, wherein the catalyst is p-toluene sulfonic acid monohydrate and the chemical reaction is selected from oxazole synthesis, Fischer Indole synthesis, deprotection of tetrahydropyran esters, and Hantzsch dihydropyridine synthesis.

### Embodiment #54

The use of embodiment 51, wherein the catalyst is (R)-(−)-1,1′-binapthyl-2,2′-diyl hydrogenphosphate and the chemical reaction is selected from the Pictet-Spengler reaction, asymmetric Mannich reaction, Friedel-Crafts and reductive amination.

### Embodiment #55

The use of embodiment 51, wherein the catalyst is tris(2,2,2-trifluoroethyl)borate and the chemical reaction is an amidation reaction.

### Embodiment #56

The use of embodiment 51, wherein the catalyst is 4-dimethylaminopyridinium acetate and the chemical reaction is an acylation.

### Embodiment #57

The use of embodiment 51 wherein the catalyst is a phospholane oxide and the chemical reaction is a catalytic Wittig reaction.

### Embodiment #58

The use of embodiment 51 wherein the catalyst is copper(I) trifluormethansulfonate and the chemical reaction is Huisgen cycloaddition.

### Embodiment #59

The use of embodiment 51 wherein the catalyst is zinc trifluoromethanesulfonate and the chemical reaction is vinylogous amide synthesis.

### Embodiment #60

The use of embodiment 51 wherein the catalyst is Scandium trifluoromethanesulfonate and the chemical reaction is benzimidazole synthesis.

### Embodiment #61

The use of embodiment 51 wherein the catalyst is Triazabicyclodecene-acetic acid and the chemical reaction is amide synthesis.

### Embodiment #62

The use of embodiment 51 wherein the catalyst is Tetrakis(triphenylphosphine) palladium(0) and the chemical reaction is Suzuki coupling.

### Embodiment #63

Apparatus for catalysing a chemical reaction comprising the article of any of embodiments 28 to 49, said article being a reaction vessel, preferably a flow reactor.

### Embodiment #64

The article, method, kit, apparatus or use according to any preceding embodiment wherein said light-curable resin composition excludes onium salts, preferably wherein said composition excludes onium salts comprising a toluene sulfonate ion.

### Embodiment #65

The article, method, kit, apparatus or use according to any preceding embodiment wherein said catalyst excludes onium salts; preferably wherein said catalyst excludes onium salts comprising toluene sulfonate anion.

### Embodiment #66

The article according to any preceding embodiment further comprising at least one coating layer.

### Embodiment #67

The article according to any preceding embodiment wherein the outermost layer of said article is surface-functionalised.

### Embodiment #68

The method according to any preceding embodiment further comprising application of a coating layer, preferably by means of dipping, rolling, spray-drying etc.

### Embodiment #69

The method according to any preceding embodiment further comprising surface-functionalisation of the outer-most layer of said article.

### Embodiment #70

The article according to any preceding embodiment comprising or consisting of a laminated core comprising multiple layers as defined in any preceding embodiment.

The above are illustrative preferred embodiments of the invention. The skilled worker will be aware from the overall disclosure and teaching herein that other embodiments are possible, without departing from the spirit and scope of the invention.

1-2. (canceled)

3. A method for producing an article, said method comprising:
a) preparing a light-curable liquid resin composition comprising:
i) a photoinitiator;
ii) at least one ethylenically unsaturated compound; and
iii) a catalyst selected from the group consisting of an organocatalyst, a metal salt and a metal-ligand complex;
b) curing at least one portion of the light-curable liquid resin by exposure to electromagnetic radiation; and
c) repeating step b) to form an article comprising successive layers of cured resin.

4. A method for producing an article, the method comprising:
a) preparing a light-curable liquid resin composition comprising:
i) a photoinitiator;
ii) at least one ethylenically unsaturated compound; and iii) a catalyst selected from the group consisting of an organocatalyst, a metal salt and a metal-ligand complex, and
b) selectively curing at least one portion of the light-curable liquid resin by exposure to electromagnetic radiation.

5. The method according to claim 3 wherein step (b) is performed by means of a process comprising three-dimensional printing.

6. The method of claim 3, wherein the at least one portion of the light-curable liquid resin is selectively cured based on instructions provided in an electronic file.

7. The method of claim 3, wherein, after step (b), the cured portion of the light-curable liquid resin is moved, by a distance corresponding to at least the thickness of the cured portion, away from the surface of the light-curable liquid resin, before a further portion of the light-curable liquid resin is cured and adhered to the previously cured portion.

8. The method of claim 3, wherein the method further comprises curing sequential layers of the light-curable liquid resin until the production of the article is complete.

9. The method of claim 3, wherein the photoinitiator is a free radical photoinitiator, a cationic photoinitiator or a combination thereof; or
the photoinitiator is selected from the group consisting of a phosphine oxide, an α-hydroxyketone, a benzophenone derivative, a titanocene, a thioxanthone and an onium salt and combinations thereof; or
the photoinitiator is diphenyl(2,4,6-trimethylbenzoyl)phosphine oxide.

10-11. (canceled)

12. The method according to claim 3, wherein the photoinitiator is present in the light-curable liquid resin composition in an amount of from 0.01 to 6% w/w, based on the total weight of the resin composition.

13. The method according to claim 3, wherein the ethylenically unsaturated compound comprises at least one of (meth)acrylate, (meth)acrylamide, epoxide, vinyl ether, vinyl ester, vinyl sulfonate, styrene, N-vinylpyrrolidone, vinylcaprolactam and combinations thereof; or
the ethylenically unsaturated compound is selected from at least one of 1,6-hexanedioldiacrylate, 2-(2-ethoxy)ethyl acrylate, 2-phenoxyethyl acrylate, isodecyl acrylate, ethoxylated-4-phenyl acrylate, 3,3,5-trimethyl cyclohexanol acrylate, iso octyl acylate, tridecyl acrylate, isobornyl acrylate, polyethylene glycol)diacrylate, polybutadiene diacrylate, bisphenol A propoxylate diglycidyl ether and combinations thereof; or
wherein the ethylenically unsaturated compound is selected from at least one of isobornyl acrylate, poly(ethyleneglycol)diacrylate, bisphenol A ethoxylate diacrylate and combinations thereof; or
wherein the ethylenically unsaturated compound is poly(ethylene glycol)diacrylate and the photoinitiator is diphenyl(2,4,6-trimethylbenzoyl)phosphine oxide.

14-15. (canceled)

16. The method according to claim 3, wherein the ethylenically unsaturated compound is present in the light-curable liquid resin composition in an amount of greater than 30% w/w, based on the total weight of the resin composition.

17. The method according to claim 3, wherein the liquid resin composition further comprises a cross-linker.

18. The method according to claim 3, wherein the catalyst is an organocatalyst.

19. The method according to claim 18, wherein the organocatalyst is selected from the group consisting of p-toluene sulfonic acid, tris(2,2,2-trifluoroethyl)borate, (R)-(−)-1,1′-binaphthyl-2,2′-diyl hydrogenphosphate, 4-dimethylaminopyridinium acetate, piperidine and phospholane oxides.

20. (canceled)

21. The method according to claim 3, wherein the catalyst is present in the light-curable liquid resin composition in an amount of from 1 to 15% w/w.

22. The method according to claim 3, wherein the light-curable liquid resin composition further comprises a photoinhibitor.

23. The method according to claim 22, wherein the photoinhibitor is selected from the group consisting of 4-methoxy phenol, Sudan I, 2-(hydroxyphenol)benzotriazole and 2-(2′-hydroxy-3′tert-butyl-5′-methylphenyl)-5-chlorobenzotriazole.

24. The method according to claim 22, wherein the photoinhibitor is present in the light-curable liquid resin composition in an amount of from 0.01 to 2% w/w.

25. The method of claim 3, wherein the article is selected from the group consisting of a magnetic stirrer bar holder, a stirrer, a reaction vessel, a paddle, a cartridge for flow hydrogenation systems, an insert for a microwave reactor, and a stirrer for a microwave reactor.

26. (canceled)

27. An article obtained by the method of claim 3.

28-29. (canceled)

30. The method according to claim 3 wherein said catalyst excludes onium salts.
